(19) United States
(12) Patent Application Publication
(10) Pub. No.: US 2025/0071254 A1
(43) Pub. Date: Feb. 27, 2025

(54) SCALING OF THREE-DIMENSIONAL CONTENT FOR DISPLAY ON AN AUTOSTEREOSCOPIC DISPLAY DEVICE

(71) Applicant: DIMENCO HOLDING B.V., Veldhoven (NL)

(72) Inventors: Silvino José Antuña PRESA, Veldhoven (NL); Sander Johannes BROUWERS, Veldhoven (NL); Jurjen CAARLS, Veldhoven (NL)

(21) Appl. No.: 18/724,317

(22) PCT Filed: Dec. 27, 2022
(86) PCT No.: PCT/NL2022/050761

§ 371 Date: Jun. 26, 2024

(30) Foreign Application Priority Data
Dec. 28, 2021 (NL) 2030325

(51) Int. Cl. H04N 13/398; H04L 12/18; H04N 13/111; H04N 13/125; H04N 13/128; H04N 13/189; H04N 13/305; H04N 13/31; H04N 13/327; H04N 13/366

(52) U.S. Cl. CPC H04N 13/398; H04L 12/1831; H04N 13/111; H04N 13/128; H04N 13/189; H04N 13/327; H04N 13/366; H04N 13/125; H04N 13/305; H04N 13/31

(57) ABSTRACT

The invention relates to a method for driving a screen of an autostereoscopic display device to present a three-dimensional image to a viewer, the method comprising scaling of the three-dimensional image. taking into account 1) the 5 viewing distance of the viewer's eyes to the screen: and 2) the recording distance of the object. In this way. a the three-dimensional image of one or more specific objects in a scene can be scaled in such way that the scene and the object(s) therein become a realistic part of the real environment of the viewer. It is also possible to display a background image on the screen wherein the background 10 image is also scaled to realistic dimensions.

### FIELD OF THE INVENTION

The invention relates to a method for driving a screen of an autostereoscopic display device to present a three-dimensional image to a viewer residing in a field of view of the screen.

### BACKGROUND

Autostereoscopic displays have attracted great attention in the last two decades. One of their most outstanding features is that they allow a viewer to perceive three-dimensional images without a dedicated eyewear device, also when the viewer moves relative to the display. Key to this technology is the presence of a screen that comprises a lenticular lens or parallax barrier. This enables that the autostereoscopic display simultaneously directs a left eye image to a left eye of the viewer and a right eye image to a right eye of the viewer. The resulting three-dimensional image provides a depth perception wherein elements in the image may appear in front of the display or further away than the display (‘behind’ the display). The absence of any dedicated eyewear device allows a viewer to experience that he is physically present in the real world, while the autostereoscopic display forms a virtual window to another world—a truly believable virtual world that is also three-dimensional.

A shortcoming of such virtual windows, however, is that the dimensions of the displayed content are often not perceived by the viewer as matching with those of the actual scene that has been recorded. For example, when a viewer sees an item (e.g. an object or a person) that is contained in a field of view of a virtual window (i.e. an item visible ‘through’ the virtual window), the dimensions of this displayed item usually do not match those of the real item when it would be observed from the same distance through a real window. This is of course neither the case when a plurality of items is present.

A further discrepancy with reality is that when the viewer moves towards or away from the virtual window, the size of any displayed item does not change accordingly.

Thus, it appears that known autostereoscopic displays have some shortcomings as regards realistically presenting a three-dimensionally recorded item to a viewer, in particular in a setting wherein the autostereoscopic display acts as a virtual window.

### SUMMARY OF THE INVENTION

It is therefore an object of the present invention to provide a method to improve the experience of a viewer when watching an autostereoscopic display; for example when the viewer ‘looks through a virtual window’ to see another object or person. It is in particular an object of the present invention to provide a method that improves the experience of a viewer in a teleconference.

It has now been found that one or more of these objects can be reached by a proper scaling of three-dimensional content that is to be displayed by the autostereoscopic display.

Accordingly, the present invention relates to a method for driving a screen of an autostereoscopic display device to present a three-dimensional image of an object in a scene to a viewer residing in a field of view of the screen, the method comprising
providing a three-dimensional recording of an object in a scene, using a stereo camera;
displaying the three-dimensional recording of the object as a three-dimensional image on the screen;
wherein the method comprises a step wherein the three-dimensional image of the object is scaled, taking into account
   the viewing distance of the viewer's eyes to the screen;
   the recording distance of the object to the stereo camera.

### DETAILED DESCRIPTION OF THE INVENTION

Throughout the description and claims, the terms ‘three-dimensional image’ and ‘autostereoscopic image’, are used interchangeably and refer to the same type of image. It is herewith recognized that an autostereoscopic image is strictly spoken not the same as a three-dimensional image. An autostereoscopic image is an image that is only perceived by a viewer as being three-dimensional, since it is composed of a left image that is to be presented to a left eye of the viewer and a right image that is to be presented to a right eye of the viewer.

In the context of the invention, by the term ‘left image’ is meant the image that is displayed by an autostereoscopic display device intended for the left eye. Correspondingly, by the term ‘right image’ is meant the image that is displayed by an autostereoscopic intended for the right eye. Herein, it is understood that, in practice, there is always a (very) small portion of light that ‘leaks’ to the other eye, which effect is known as crosstalk. Viewers may however not always be aware of this and still rate their three-dimensional viewing experience as satisfying.

In the context of the invention, a three-dimensional recording is meant to contain information that represents a three-dimensional visible image in that it can be used to display such three-dimensional image, when inputted to an autostereoscopic display device in a format processable by this device. A three-dimensional recording (of e.g. a scene, person or object in the real world) is a record or live-stream of a real scene or object, captured by a stereo camera and comprising information on the three-dimensionality of the scene or object. It may be stored in a memory part associated with the device so that it can be displayed on request; or it may be displayed as live video that is captured by a stereo camera associated with the autostereoscopic display device (such camera may be a camera remote from the device, e.g. configured to capture a scene or object in a different environment).

In the context of the invention, by the term ‘stereo camera’ is meant a camera that is capable of providing a three-dimensional recording of a real scene or object, from which recording a stereoscopic or three-dimensional image can be made. For the purpose of the invention, a stereo camera is meant to include a stereoscopic camera and a plenoptic camera. Further, the term stereo camera may comprise a plurality of (stereo) cameras that together from and provide the capabilities of a stereo camera as set out above.

In the context of the invention, by the term ‘viewer’ is meant a person consuming the content that is presented to him according to the method of the invention. Besides viewing the three-dimensional image, the viewer may also experience other sensory stimulus such as sound or haptic stimulus. For convenience, however, such person is consequently referred to as ‘viewer’, although it is understood that he may at the same time also be e.g. a ‘listener’. Throughout the text, references to the viewer will be made by male words like ‘he’, ‘him’ or ‘his’. This is only for the purpose of clarity and conciseness, and it is understood that female words like ‘she’, and ‘her’ equally apply.

A method of the invention makes use of an autostereoscopic display device. This is typically a device that is largely stationary in the real world during its use, such as a desktop device or a wall-mounted device. For example, the autostereoscopic display device is a television, a (desktop) computer with a monitor, a laptop, or a cinema display system. It may however also be a portable device such as a mobile phone, a display in a car, a tablet or a game console, allowing a viewer to (freely) move in the real world together with the autostereoscopic display device.

Autostereoscopic display devices are known in the art, e.g. from WO2013120785A2. The main components of an autostereoscopic display device used in a method of the invention typically are an eye tracking system, a screen, a processing unit, and optional audio means.

The eye tracking system comprises means for tracking the position of the viewer's eyes relative to the autostereoscopic display device and is in electrical communication with the processing unit. The eye position is required for correctly weaving the left eye image and the right eye image to the array of pixels, so that each image hits the intended eye even when the viewer moves relative to the screen of the autostereoscopic display device.

The viewing distance of the viewer's eyes to the screen is typically also obtained from the eye tracking system. Alternatively, it is possible that separate means are present for determining this viewing distance.

The recording distance of a viewer relative to the stereo camera may be obtained by using the eye tracking system or a different system that is associated with or integrated in the stereo camera.

The screen comprises means for displaying a three-dimensional image to a viewer whose eyes are tracked by the eye tracking system. Such means comprise an array of pixels for producing a display output and a parallax barrier or a lenticular lens that is provided over the array to direct a left image to the viewer's left eye and a right image to the viewer's right eye.

The processing unit is inputted with the three-dimensional recording and configured to drive the screen, taking into account the data obtained by the eye tracking system. An important component of the processing unit is therefore the so-called ‘weaver’, which weaves a left image and a right image to the array of pixels, thereby determining which pixels are to produce pixel output in correspondence with the respective image. In this way, a three-dimensional image can be displayed to a viewer at a particular position.

The processing unit is typically also configured to perform the scaling of a three-dimensional image in accordance with the method of the invention.

The optional audio means comprise means for playing sound to the viewer. For example, audio means comprises one or more devices selected from the group of stereo loudspeakers, loudspeaker arrays, head phones and ear buds.

An autostereoscopic display device used in a method of the invention typically comprises a receiver for receiving a three-dimensional recording of a scene or object in the real world. This also includes receiving a live video stream of a scene or object in the real world. An audio recording and/or audio stream may also be received by such receiver. Transfer of video and/or audio recordings may occur via e.g. a wireless connection or a telecommunications line.

An autostereoscopic display device used in a method of the invention may comprise memory to store a three-dimensional recording of a scene or object in the real world.

At the scene where the actual three-dimensional recording takes place (or has taken place), also one or more devices are present. Such devices are a stereo camera and a means for determining the recording distance of a recorded object to the stereo camera. The latter device may be integrated in the stereo camera. Optionally, an audio recording device and/or an illuminating device is present at the scene of the three-dimensional recording.

Devices at the scene of the three-dimensional recording are usually not physically part of the autostereoscopic display device, but may be associated with it via e.g. a telecommunications line.

The inventors realized that known autostereoscopic display devices are, in a certain aspect, capable of displaying three-dimensional images just as a normal television displays two-dimensional images: the field of view of the means that records the images is basically fit into the screen of the device, i.e. the edges of the recorded scene also form the edges of the displayed image of the scene. On certain occasions, displayed content may be scaled for convenience, but this is usually not according to the apparent size. Moreover, different objects at different recording distances would require a different degree of scaling, which is not possible when an image is scaled as a whole. It appeared that these shortcomings with respect to scaling have the effect that the displayed content is not experienced as being a natural part of the real environment of the viewer. In other words, such displayed content impairs an immersive experience of the viewer.

It has now been found that an increased immersion can be achieved when one or more particular objects in a scene are recorded and measured separately; and when their displaying as a three-dimensional image comprises a scaling that takes into account the viewing distance of the viewer's eyes to the screen as well as the recording distance of the object to the stereo camera. In this way, the dimensions of an object as perceived from the displayed three-dimensional image can be adjusted to such extent that they match those of the object when the object is perceived in the real world (the screen then functions as a virtual window).

Such size perception of an object has everything to do with the distance at which the object is observed, not only at the viewing side but also at the recording side. In the display of a real object on a screen, there are two types of observation distances. The first type is the recording distance, i.e. the distance between a (stereo) camera and the object. The second type is the viewing distance, i.e. the distance between the eyes of the viewer and the screen on which an image of the object is displayed.

At a short observation distance, the angle of view (field of view) is large and the object covers a large portion of the surface of the viewer's retina or the camera's image sensor. Conversely, at a long observation distance, the angle of view (field of view) is small and the object covers a small portion of the surface of the viewer's retina or the camera's image sensor. For a realistic perception at the viewing side of the dimensions that occur in the real world (i.e. on the recording side), the angle of view on the recording side has to be the same as that on the viewing side. Given a certain recording distance and viewing distance (depending on time and circumstances), the most preferrable way to arrive at a matching viewing angle is to (real-time) scale the image on the viewing side (i.e. on the screen). This is reflected in the method of the invention. A person skilled in the art can calculate which extent of scaling applies when the recording distance and the viewing distance are known, using common mathematic principles and without exercising any inventive effort.

For the purpose of the invention, objects that are to be scaled this way are typically present at a distance from the stereo camera that is within a range where stereoscopy is possible. Typically this is at a distance of less than 25 m, preferably at a distance of less than 10 m, more preferably at a distance of less than 7 m and even more preferably at a distance of less than 5 m. For example, it is less than 4 m, less than 3 m or less than 2 m.

A preferred way of achieving such scaling is by defining an apparent size of a to-be-recorded object in the real world and translating this to the displaying of an image of the recorded object on a screen. To this end, an apparent size is also defined for the object as displayed on the screen. The term ‘apparent size’ of an object is meant to indicate the angular distance from one side of the object to the opposite side of the object. This can be thought of as the angular displacement through which an eye or camera must rotate to look from the one side to the opposite side.

Within this context, the apparent real world size of an object is the angular size that is perceived by a person in the real world whose distance to the object is the distance of the stereo camera to the object that is recorded by the stereo camera (i.e. the person's viewpoint is the viewpoint of the stereo camera). Correspondingly, the apparent displayed size of the object is the angular size that is perceived by the viewer of the autostereoscopic display device when the three-dimensional image is displayed on the screen.

In the method of the invention, the three-dimensional image is preferably scaled in such way that the apparent displayed size matches the apparent real world size. Such match means that the three-dimensional image and the real object are perceived as having the same size (e.g. both are perceived as having the same height and both are perceived as having the same width). In this way, it can be determined to which extent the three-dimensional image has to be scaled in order to have a matching apparent size. The result is then that the scaled three-dimensional image becomes a realistic part of the real environment of the viewer.

The apparent displayed size may however also be set at a certain desired percentage of that of the apparent real world size (i.e. a percentage other than 100%, since then both apparent sizes match). This may be the case when realistic dimensions are less important and/or when it is undesired that an object covers an exceptionally large or an exceptionally small part of the screen. For example, the desired percentage is in the range of 50-150%, in particular in the range of 80-120%, more in particular in the range of 95-105% and even more in particular in the range of 99-101%.

Equivalent to determining the apparent size of a (displayed or real) object, is determining the apparent size of a feature of such object. For example, when the object is a knife, the feature may be its blade. Or when the object is a human head, it may be the distance between the eyes.

Accordingly, a method of the invention may comprise the steps of
a) determining the recording distance of the object to the stereo camera;
b) determining the viewing distance of the viewer's eyes to the screen;
c) defining a feature of the object, the feature being included in the three-dimensional image;
d) determining an apparent real world size of the feature, which is the angular size of the feature when the feature is viewed in the real world from the recording distance obtained under a);
e) determining an apparent displayed size of the feature, which is the angular size of the feature when the feature is viewed as a three-dimensional image on the screen from the viewing distance obtained under b);
f) scaling the three-dimensional image by adjusting the apparent displayed size determined under e) in the three-dimensional image
to
a desired percentage of the apparent real world size obtained under d);

g) fitting the three-dimensional image that is scaled in step f) to the screen by cropping the three-dimensional image when the three-dimensional image is larger than the screen.

The method of the invention is not restricted to the scaling of one object. It is also possible to scale a plurality of objects and display them simultaneously. Accordingly, the method may be a method wherein
there are a plurality of objects in the scene;
the method is performed for each object of the plurality of objects;
a plurality of three-dimensional images is simultaneously displayed on the screen, wherein each image is scaled independently of one another, taking into account the viewing distance of the viewer's eyes to the screen and the recording distance of the object to the stereo camera.

In an alternative wording, the method may be a method comprising
providing a first three-dimensional recording of a first object in a scene and a second three-dimensional recording of a second object in the scene, both recordings being obtained by a stereo camera;
simultaneously displaying the first three-dimensional recording as a first three-dimensional image on the screen and the second three-dimensional recording as a second three-dimensional image on the screen;
wherein the first and the second three-dimensional image are scaled independently of one another to a desired extent, taking into account
   the viewing distance of the viewer's eyes to the screen;
   the recording distance of the respective object to the stereo camera (i.e. for the scaling of the first three-dimensional image, the recording distance of the first object to the stereo camera is taken into account; and for the scaling of the second three-dimensional image, the recording distance of the second object to the stereo camera is taken into account).

It is noted that the (simultaneous) displaying of separate recordings of one or more objects on a screen typically requires that the objects have previously been segmented from one another and from a background, as a recording usually comprises a complete scene of which the one or more objects form a part. This applies all the more when the objects are scaled independently of one another. The segmentation of objects from the rest of a scene they are in, is known in the art. Any such segmentation is therefore a standard procedure to the skilled person.

The scene where the actual three-dimensional recording takes place, may, besides one or more objects, comprise a background. In the context of the invention, by a background is meant any part of the scene that is at a distance from the stereo camera in the range of 7 m to infinity, in the range of 10 m to infinity, in the range of 15 m to infinity, in the range of 25 m to infinity or in the range of 50 m to infinity. Due to its relative remoteness from the stereo camera, a background may be scaled as a whole. Accordingly, a method of the invention may comprise
providing a recording of the background in the scene, obtained by a camera or a stereo camera;
simultaneously displaying 1) the recording of the background as a background image on the screen and 2) the three-dimensional recording of the object as a three-dimensional foreground image on the screen; or of a plurality of objects as three-dimensional foreground images on the screen;
wherein the method comprises a step wherein the background image is scaled, taking into account
   the viewing distance of the viewer's eyes to the screen;
   a field of view of the camera or stereo camera.

In a preferred embodiment, this method is performed by further performing the steps of
a) determining the viewing distance of the viewer's eyes to the screen;
b) determining the field of view of the camera or stereo camera;
c) imaginarily positioning the background image in the display plane of the screen so that the background image plane coincides with the display plane of the screen;
d) determining to which extent the background image has to be imaginarily scaled to allow the viewer to imaginarily see, from the viewing distance obtained under a), the background image with a field of view that corresponds to a desired percentage of the field of view of the camera or stereo camera obtained under b);
e) scaling the background image to the extent obtained under d) and displaying it on the screen;
f) fitting the background image that is scaled in step e) to the screen by cropping the background image where the background image is larger than the screen.

By imaginarily positioning the background image in the display plane of the screen is meant that, in the setting wherein the viewer is in front of the screen at a distance obtained under a), the background image is displayed in a fictive or virtual way in a plane that coincides with the display plane of the screen. Herein, the dimensions (e.g. length and width) of the imaginarily displayed background image are not limited to the screen dimensions. Given the viewer's viewing distance to the screen and the field of view with which he needs to see the background image (which is a desired percentage of the field of view of the camera or stereo camera obtained under a)), the extent to which the background image has to be imaginarily scaled is determined. A person skilled in the art can calculate such extent of scaling when the viewer's viewing distance to the screen and the (desired percentage of the) field of view of the camera or stereo camera are known, using common mathematic principles and without exercising any inventive effort.

This imaginary scaling extent is subsequently applied to the real displaying of the background image. When the result is that the background image is larger than the screen, then the background image will be cropped where it is larger than the screen. When it is smaller than the screen, then one may decide that a background image is to be lacking at certain positions, or that another image is to be displayed where a background image is lacking.

In the method of the invention, the background image is preferably scaled in such way that the field of view with which the viewer sees the background image matches the field of view of the camera or stereo camera. Such match means that the background image and the real background are perceived as having the same size (e.g. both are perceived as having the same height and both are perceived as having the same width). With this setting (i.e. matching fields of view), it can be determined to which extent the background image has to be scaled. The result is then that the scaled background image becomes a realistic part of the real environment of the viewer.

The field of view with which the viewer sees the background may however also be set at a certain desired percentage of that of the camera or stereo camera (i.e. a percentage other than 100% where both fields of view match). This may be the case when realistic dimensions are less important and/or when it is desired that a background is enlarged or reduced. For example, the desired percentage is in the range of 50-150%, in particular in the range of 80-120%, more in particular in the range of 95-105% and even more in particular in the range of 99-101%.

A method of the invention may advantageously be applied in teleconferencing, allowing another person who is remote from the viewer to communicate to the viewer and vice versa. In such setting, the other person and the viewer preferably both have means that can carry out the method of the invention; the autostereoscopic display device of the viewer then comprises the stereo camera that operates according to the method of the invention with the autostereoscopic display device of the other person. It provides a three-dimensional recording of the viewer so that the other person can see three-dimensional image of the viewer-and vice versa.

It is also possible however, that the stereo camera of the viewer displays the recording of the viewer to the viewer (and not to the other person). Thus, in a method of the invention, the stereo camera may be configured to record the viewer in the field of view of the screen, so that the screen may display a recording of the viewer to the viewer. In such case, the viewer views a three-dimensional image of himself-the autostereoscopic display device of the viewer may thus be regarded as a virtual mirror. To this end, the displayed three-dimensional image is preferably mirrored.

In an embodiment, the scaling according to the method of the invention may be repeated one or more times during the displaying of the three-dimensional image to account for a change of the position of the viewer's eyes relative to the screen.

In another embodiment, the entire method is repeated one or more times to account for 1) a possible change in the scene, such as a change in the recording distance of the object to the stereo camera; and 2) a possible change of the position of the viewer's eyes relative to the screen. For example, it is repeated at a rate of at least one repetition per second, at a rate of at least 10, least 25, at least 40 or at least 50 repetitions per second. In particular, the rate is in the range of 27-33, in the range of 57-63 or in the range of 87-93 repetitions per second. A high rate produces sequential images at a high frequency, which is perceived by the viewer as a movie. A high rate also means that there is a more timely accommodation for changes in the viewing distance of the viewer's eyes to the screen and for changes in the recording distance of the object to the stereo camera. For example, when the viewer makes fast movements relative to the autostereoscopic display device, and/or when the object makes fast movements relative to the stereo camera, these movements are timely accounted for when the method of the invention is carried out at a high repetition rate.

In a method of the invention, the three-dimensional recording may be stored on a data carrier such as a memory stick or a hard disk. The autostereoscopic display device then obtains the three-dimensional recording from such storage. Alternatively, the autostereoscopic display device obtains the three-dimensional recording ‘live’ without reading it from a memory. Accordingly, in a method of the invention, the three-dimensional recording may be contained in a memory part associated with the autostereoscopic display device or it may be a live video stream originating from the scene where the actual three-dimensional recording takes place.

1. Method for driving a screen of an autostereoscopic display device to present a three-dimensional image of an object in a scene to a viewer residing in a field of view of the screen, the method comprising
providing a three-dimensional recording of an object in a scene, obtained by a stereo camera;
displaying the three-dimensional recording of the object as a three-dimensional image on the screen;
wherein the three-dimensional image of the object is scaled to a desired extent, taking into account
the viewing distance of the viewer's eyes to the screen;
the recording distance of the object to the stereo camera.

2. Method according to claim 1, wherein the method comprises the steps of
a) determining the recording distance of the object to the stereo camera;
b) determining the viewing distance of the viewer's eyes to the screen;
c) defining a feature of the object, the feature being included in the three-dimensional image;
d) determining an apparent real world size of the feature, which is the angular size of the feature when the feature is viewed in the real world from the recording distance obtained under a);
e) determining an apparent displayed size of the feature, which is the angular size of the feature when the feature is viewed as a three-dimensional image on the screen from the viewing distance obtained under b);
f) scaling the three-dimensional image by adjusting the apparent displayed size determined under e) in the three-dimensional image to
a desired percentage of the apparent real world size obtained under d);
g) fitting the three-dimensional image that is scaled in step f) to the screen by cropping the three-dimensional image where the three-dimensional image is larger than the screen.

3. Method according to claim 1, wherein the three-dimensional recording is contained in a memory part associated with the autostereoscopic display device or wherein the three-dimensional recording is a live video stream.

4. Method according to any one of claim 1, wherein
there is a plurality of objects in the scene;
the method is performed for each object of the plurality of objects;
a plurality of three-dimensional images is simultaneously displayed on the screen, wherein each image is scaled independently of one another.

5. Method according to claim 1, the method comprising
providing a first three-dimensional recording of a first object in a scene and a second three-dimensional recording of a second object in the scene, both recordings being obtained by a stereo camera;
simultaneously displaying the first three-dimensional recording as a first three-dimensional image on the screen and the second three-dimensional recording as a second three-dimensional image on the screen;
wherein the first and the second three-dimensional image are scaled, taking into account
the viewing distance of the viewer's eyes to the screen;
the recording distance of the respective object to the stereo camera.

6. Method according to claim 1, wherein there is a background in the scene at a distance from the stereo camera in the range of 10 m to infinity, in particular from 25 m to infinity, the method further comprising
providing a recording of the background in the scene, obtained by a camera or a stereo camera;
simultaneously displaying 1) the recording of the background as a background image on the screen and 2) the three-dimensional recording of the object as a three-dimensional foreground image on the screen; or of a plurality of objects as three-dimensional foreground images on the screen;
wherein the background image is scaled, taking into account
the viewing distance of the viewer's eyes to the screen;
the field of view of the camera or stereo camera.

7. Method according to claim 6, wherein the method comprises the steps of
a) determining the viewing distance of the viewer's eyes to the screen;
b) determining the field of view of the camera or stereo camera;
c) imaginarily positioning the background image in the display plane of the screen so that the background image plane coincides with the display plane of the screen;
d) determining to which extent the background image has to be imaginarily scaled to allow the viewer to imaginarily see, from the viewing distance obtained under a), the background image with a field of view that corresponds to a desired percentage of the field of view of the camera or stereo camera obtained under b);
e) scaling the background image to the extent obtained under d) and displaying it on the screen;
f) fitting the background image that is scaled in step e) to the screen by cropping the background image where the background image is larger than the screen.

8. Method according to claim 1, wherein the object is a human head.

9. Method according to claim 1, wherein the method is used in teleconferencing.

10. Method according to claim 1, wherein the stereo camera is configured to record the viewer in the field of view of the screen.

11. Method according to claim 10, wherein the displayed three-dimensional image is mirrored.

12. Method according to claim 2, wherein the desired percentage is in the range of 50-150%, in particular in the range of 80-120%, more in particular in the range of 95-105% and even more in particular in the range of 99-101%.

13. Method according to claim 1, wherein the scaling is repeated one or more times during the displaying of the three-dimensional image to account for a change of the position of the viewer's eyes relative to the screen.

14. Method according to claim 1, wherein the method is repeated one or more times to account for a change in the recording distance of the object to the stereo camera and/or for a change of the position of the viewer's eyes relative to the screen.

15. Method according to claim 1, wherein the autostereoscopic display device is selected from the group of televisions, desktop computers, laptops, cinema display systems, mobile phones, displays in a car, tablets and game consoles.
